(19) United States
(12) Patent Application Publication
(10) Pub. No.: US 2025/0224698 A1
(43) Pub. Date: Jul. 10, 2025

(54) METHOD FOR DETERMINING A REFERENCE VALUE AND METHOD FOR SETTING A REFERENCE VALUE

(71) Applicant: ROLEX SA, Geneva (CH)

(72) Inventors: Félix Grasser, Grand-Lancy (CH); Cédric Hentsch, Geneva (CH); Olivier Hunziker, Vevey (CH)

(73) Assignee: ROLEX SA, Geneva (CH)

(21) Appl. No.: 18/702,677

(22) PCT Filed: Sep. 26, 2022
(86) PCT No.: PCT/EP2022/076727

§ 371 Date: Apr. 30, 2024

(30) Foreign Application Priority Data
Oct. 20, 2021 (EP) 21203825.1

(51) Int. Cl. G04C 3/10

(52) U.S. Cl. CPC G04C 3/10

(57) ABSTRACT

The method for determining, in particular for calculating, a reference value of an oscillator in a clock movement includes: —setting the oscillator into oscillation with respect to a frame of the clock movement; —positioning the clock movement in a plurality of predetermined positions with respect to the direction of Earth's gravity; —determining, for each position, a piece of data relating to the reference frame of the oscillator; and—using the determined piece of data to determine a value of the reference frame of the oscillator, in particular an oriented value of the reference frame and/or a function defining the oriented value of the reference frame according to the position of the clock movement with respect to the direction of Earth's gravity.

The invention concerns a method for determining a timepiece beat value. The invention also concerns a method for setting a timepiece beat value. The invention further concerns a method for determining drift of a beat value of a timepiece movement. The invention further concerns a method for determining a geometry of an arrangement of an oscillator in a timepiece movement. The invention further concerns a timepiece movement obtained using such a setting method or a timepiece movement set using such a setting method. The invention finally concerns a timepiece including such a timepiece movement.

### BACKGROUND ART

The beat value is one of three values routinely measured during chronometric measurements, together with the rate and the amplitude.

According to the usual theory, the beat value corresponds to an alignment error in the equilibrium position of the balance and the hairspring relative to the line of centers that connects the pivot points of the balance and the hairspring and the pallet assembly of the escapement. The equilibrium position of the balance at rest should ideally be situated on this line in order to have half-oscillations of the same duration. If the equilibrium position is not situated on the line of centers the oscillation angle between the line of centers and the return point of the balance and the hairspring will not be identical on either side of the line of centers.

The beat value is a magnitude that characterizes the asymmetry of the oscillation of the balance. At rest (with no torque in the transmission chain or in the hairspring) the balance is located at its rest point. During an oscillation with a beat value other than zero the half-oscillations on either side of the line of centers have different amplitudes and durations. The beat value is therefore traditionally expressed in milliseconds and calculated by identifying the moments of the impacts during disengagement (as represented in FIG. 1). The beat value is given by the formula:

$$Beat value = \vert t 1 - t 2 \vert / 2$$

For example, in FIG. 1 the beginning of the period t1 corresponds to a pin of the balance roller coming into contact with a first horn of the fork of the pallet assembly and the end of the period t1 corresponds to the pin of the balance roller coming into contact with the second horn of the fork. In a similar manner, the beginning of the period t2 corresponds to the pin of the balance roller coming into contact with the second horn of the fork and the end of the period t2 corresponds to the pin of the balance roller coming into contact with the first horn of the fork.

The objective of the watchmaker is usually to set the beat value to zero based on chronometric measurements carried out using the timing machine.

The document “Technique de mesure et analyses des défauts de la montre” posted online by Witschi, a supplier of chronometric measuring instruments, at https://www.witschi.com/assets/files/sheets/Witschi%20Formation.pdf, from which FIG. 1 is drawn, indicates that this asymmetry can be made visible on a timing machine with a beat value measured in milliseconds [ms] and corresponding to the duration difference between the “tick” half-cycle and the “tock” half-cycle divided by two, that is to say (t1−t2)/2, with t1>t2. It also states that high-quality watches include a particular device for setting the beat value (a hairspring stud holder), that the beat value should be equal to zero, and that the permitted range of values is from 0.0 to 0.5 ms.

In “Théorie d'horlogerie” published by L'Ecole Technique de la Vallée de Joux, C.-A. Reymondin et al., the beat value is covered by a short paragraph in section 7.7 and section 7.11.7 entitled “Contrôles avant le réglage” which specifies that “it is essential to perform the following tests on the watch, in this order and in all positions: [ . . . ] the balance must be at the beat value”. This means that the beat value must not only be zero but also that this condition must be met in all measurement positions.

“Théorie de la construction horlogère pour ingénieurs” by M. Vermot and S. Dordor, published by the Haute-Ecole Arc Ingénierie, refers to the beat value and setting it in two sentences with no additional details.

“Théorie des échappements” by C. Hugenin, S. Guye and M. Gauchet (Technicum Neuchatelois) also mentions that a beat value error has no direct impact on the functioning of the watch.

Nevertheless, watchmakers are sensitized to the importance of the beat value during their training: a beat value at zero in all positions is traditionally a sign of good functioning of a mechanical watch. A beat value set properly is therefore considered as a gage of watchmaking quality (the term “beat error” is used) and this requires very particular attention during setting. Moreover, a beat value that is not set correctly may indicate that the watch has been dropped or hit.

The application EP2570868A1 concerns an oscillator of which the collet, the hairspring and the roller are in one piece. It is mentioned therein that: “ . . . the collet of the hairspring must be mounted on the balance shaft so that at the dead or equilibrium point of this hairspring the center of the pin of the roller is situated on a straight line passing through the shaft of the balance and the shaft of the pallet assembly. The hairspring and the large roller being mounted independently of one another on the shaft of the balance, this condition is virtually never achieved. This is why there is provided on the cock of the timepiece movement a mobile hairspring stud holder to the exterior end of which the hairspring is fixed and which is able to rotate coaxially with the balance shaft to enable the escapement to be set to the beat value i.e. to make it possible to satisfy the condition stated above.”

### SUMMARY OF THE INVENTION

The aim of the invention is to provide methods for improving timepiece devices known from the prior art. In particular, the invention proposes a method for reliable and precise determination of beat values and methods making it possible to simplify the setting of the beat value and to render it reliable. Furthermore, the invention proposes methods for determining drift of the beat value of a timepiece movement and for determining an oscillator arrangement geometry.

Methods in accordance with the invention are defined by the claims.

Objects of the invention in another aspect are defined by the following propositions:
1. Method for determining, in particular for calculating, a beat value of an oscillator (2), in particular a balance (21) and hairspring (22) oscillator, in a timepiece movement (200), the method including at least the following steps:
   Causing the oscillator to oscillate relative to a frame (99) of the timepiece movement,
   Positioning the timepiece movement in at least two distinct positions defined relative to the direction of terrestrial gravity,
   For each position, determining by measurement and processing as an absolute value the beat value of the oscillator (2),
   Using data from the preceding step to calculate:
      an oriented beat value of the oscillator (2), and
      a function defining the oriented beat value of the oscillator (2) depending on the position of the timepiece movement relative to the direction of terrestrial gravity.
2. Method according to proposition 1 wherein the beat value is a temporal value.
3. Method according to either one of propositions 1 and 2 wherein the oscillator has an oscillation axis at an angle of at least 2° or of at least 3° to the direction of terrestrial gravity:
   in one of the positions of the step of positioning the timepiece movement, or
   in some of the positions of the step of positioning the timepiece movement, or
   in all of the positions of the step of positioning the timepiece movement.
4. Method according to any one of propositions 1 to 3 wherein at least one of the distinct and defined positions is such that the angle between:
   the orthogonal projection of the line of centers (L) on a plane (P) of the timepiece movement and
   an orthogonal projection of the direction of terrestrial gravity on the plane (P) of the timepiece movement
   is zero or has an absolute value less than 5° or less than 10°, and/or in that at least one of the distinct and defined positions is such that the angle between:
   the orthogonal projection of the line of centers (L) on a plane (P) of the timepiece movement and
   an orthogonal projection of the direction of terrestrial gravity on the plane (P) of the timepiece movement
   has a value of 90° or an absolute value between 85° and 95° inclusive or an absolute value between 80° and 100° inclusive.
5. Method according to any one of propositions 1 to 4 wherein at least two distinct and defined positions are vertical positions of the timepiece movement and/or are positions at an angle of approximately 90° to one another about an axis perpendicular to the frame.
6. Method according to any one of propositions 1 to 5 wherein the function defining the oriented beat value depending on the position of the timepiece movement is defined as a sinusoidal function or a polynomial function or a Bézier function or a spline function best matching the data relating to the beat value of the oscillator.
7. Method according to any one of propositions 1 to 6 wherein it includes, in particular for at least one defined position or for each defined position or for all the distinct and defined positions, a step of determining by measurement and calculation an oscillation amplitude of the oscillator (3).
8. Method according to proposition 7 wherein it includes a step of using the oscillation amplitude of the oscillator (2) to determine by calculation an angular beat value.
9. Method according to any one of propositions 1 to 8 wherein the data relating to the beat value of the oscillator (2) and/or the oscillation amplitude of the oscillator (2) are determined by processing acoustic signals previously measured or acquired or by processing acoustic and optical signals previously measured or acquired.
10. Method of adjusting an oscillator (2) wherein it includes a phase of execution of the method according to any one of propositions 1 to 9 and a phase of setting the beat value of the oscillator (2).
11. Method of adjusting an oscillator (2) wherein it includes a phase of positioning the timepiece movement in a predefined position and a phase of setting the beat value to a zero value or to a non-zero value in that predefined position.
12. Setting method according to proposition 10 or 11 wherein the phase of setting the beat value includes movement of a hairspring fixing support relative to a frame (99).
13. Method of determining drift of a timepiece movement between two states, in particular after an adjustment or an impact or magnetization, including a phase of determining the beat value of an oscillator (2) using the method according to any one of propositions 1 to 9.
14. Method for determining a geometry of an arrangement of an oscillator (3) in a timepiece movement (2), the method including:
   a phase of determining a function defining the beat value depending on the position of the timepiece movement using the method according to any one of propositions 1 to 9, and
   a phase of using the function to determine, in particular by calculation, a value representing the pivoting radial play of the oscillator (2) and/or a value representing the axial shake of the shaft of the balance and/or a value representing the diameter of the pivots of the balance.
15. Timepiece movement (200) obtained or adjusted using the setting method according to any one of propositions 10 to 12.
16. Timepiece (300), in particular wristwatch, including a timepiece movement (200) according to proposition 15.

### BRIEF DESCRIPTION OF THE DRAWINGS

The appended drawings represent by way of example mechanisms in which methods according to the invention are implemented and depict phenomena on which methods according to the invention rely.

FIG. 1 is a timeline depicting the vibrations detected at the level of the escapement of a timepiece during one period of oscillation of a balance of the timepiece.

FIG. 2 is a schematic view of a timepiece shown by way of example from the back to which methods according to the invention may be applied.

FIG. 3 is a view of an architecture of a timepiece movement shown by way of example from the dial side showing details of the orientation of a setting system.

FIG. 4 is a schematic view depicting the link between the pivot play and the variation of the beat value of a timepiece movement.

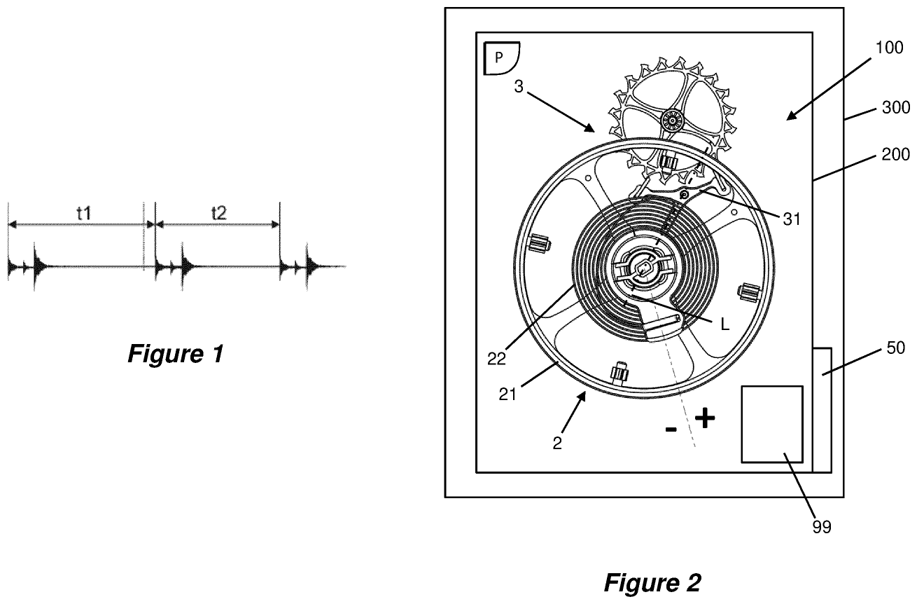

### DETAILED DESCRIPTION OF PARTICULAR EMBODIMENTS

One embodiment of a timepiece movement 300 is described in detail hereinafter with reference to FIG. 2. The timepiece 300 is for example a watch, in particular a wristwatch. The timepiece 300 includes a timepiece movement 200 to which a dial 50 is advantageously fixed. The timepiece movement is intended to be mounted in a timepiece case or casing in order to protect it from the external environment. The timepiece movement 200 may be a mechanical timepiece movement, in particular an automatic timepiece movement, or a hybrid timepiece movement.

The timepiece movement 200 includes a frame 99 and a setting system 100.

The setting system 100 includes an oscillator 2 and an escapement such as a Swiss pallet escapement 3.

The oscillator 2 includes an inertial element 21, such as a balance 21, and a return spring 22, such as a hairspring 22.

The escapement includes a pallet assembly 31 cooperating with the oscillator 2.

The line that connects the pivot points of the balance and the hairspring and the pallet assembly of the escapement is usually called the line of centers L.

### Theory and Practise of the Beat Value Concept

Although the beat value is measured by the watchmaker as a time interval, FIG. 2 shows that the beat value is defined by the angular offset between the neutral points of the escapement and of the oscillator. For historical reasons this magnitude is expressed in milliseconds [ms] and therefore characterizes half the time difference between two successive half-cycles. In practise this time depends on the speed of the oscillator and therefore on its amplitude and its frequency.

Work by the applicant has demonstrated that the measured beat value depends on the amplitude of the timepiece movement and its position during measurement. These observations have led to a redefinition of the beat value (signed beat value and geometrical beat value concepts), to the development of procedures for measuring the beat value and its sign, and to the development of applied methods exploiting these concepts.

Historically speaking the beat value has also been a zero or positive magnitude expressed in [ms] that corresponds to the absolute time difference between the equilibrium position of the oscillator (defined by the direction passing through the center of the pin of the roller of the balance at rest and the pivot axis of the balance) and the line of centers of the pivots of the balance and of the pallet assembly, with a target of setting to zero.

Following the work carried out by the applicant, it has finally appeared interesting:
to consider the beat value as a value that can be negative, zero or positive (signed or oriented beat value);
to measure the beat value as an angle, for example in [°] or [rad] (geometric beat value);
to measure the beat value experimentally in a plurality of vertical positions to determine the sign thereof and to deduce therefrom the beat value at the mid-point (that is to say the mean of the beat values in four vertical positions spaced by 90°);
to orient the timepiece movement precisely during setting of the beat value so that the beat value set in this orientation coincides with the beat value at the mid-point.

From the physical point of view the beat value is a magnitude centered on zero the sign of which depends on the sense of the angular offset. As measured at present, the beat value is not signed. Apart from the fact that this magnitude therefore does not have a normal distribution, it poses a risk of leading to false conclusions as to a difference or drift of the beat value between two states, in particular between two measurements of the same timepiece movement at two different times, such as before and after a setting operation or an impact test or exposure to a magnetic field. For example, it is possible to conclude that there is a zero drift when in reality it is the (unknown) sign that has changed, or to conclude that there is a systematic drift between two states when there is merely an effect of dispersion at the level of the timepiece movement.

It therefore seems desirable to establish a physical definition of the beat value in the form of a signed geometrical magnitude. Firstly the beat value may be rendered invariant of the amplitude by applying a conversion that takes into account the amplitude reading during the measurement. After this, the sign of this magnitude may be determined in a number of non-invasive ways, without having to modify the position of the hairspring stud holder (and therefore to misadjust the beat value) as has been done up until now.

From a geometrical point of view the beat value corresponds to the angular offset (measured as an angle of rotation of the balance) between:
the line of centers of the escapement, and
a line passing through the center of the roller pin and the axis of the balance
   in the position of the balance at which the hairspring applies a zero torque. As mentioned hereinabove the beat value has been historically defined and measured in milliseconds.

This time corresponds to the angular offset referred to hereinabove and depends on the speed of the balance at the neutral point and therefore on its amplitude and its frequency. Finally, the smaller the amplitude, the greater the time difference over two half-cycles. The objective of changing to a geometrical beat value is to apply a temporal difference to a periodic function for an angular difference that is constant and represents the direct physical cause of the offset. Taking account of the amplitude at the moment of the measurement therefore has the effect of rendering the beat value constant over the whole of discharging the barrel or despite a drift of the amplitude over time.

A mathematical development with an approximation at small angles makes it possible to express the geometric beat value as an angle by means of the following formula:

$$Rg = π \times f \times Rt \times A$$

with:
   Rg: geometrical beat value [°]
   f: oscillator frequency [Hz],
   A: timepiece movement balance amplitude [°]
   Rt: temporal beat value [s].

The beat value can therefore be expressed as an angular magnitude or as a temporal magnitude.

Conversely, the variation of the beat value as a function of the amplitude can be expressed as follows:

$$Rt ( A ) = ( {sin}^{- 1} ( Rg / A ) ) / ( π \times f ) \approx Rg / ( A \times π \times f ) for a small Rg / A$$

It is therefore clear that the temporal beat value is proportional to the reciprocal of the amplitude of the balance of the timepiece movement.

Another important aspect concerns the sign of the beat value. On the basis of the equation (t1−t2)/2 it appears that the beat value can be positive or negative depending on the values of t1 and t2. In practise the acoustic measuring equipment does not dissociate the half-cycles between the entry function and the exit function. A result of this is that this magnitude is always communicated as an absolute value.

This convention poses problems not only at the level of the statistical analysis of the data (the data obtained having a non-Gaussian distribution) but also for setting the beat value and for understanding the phenomena impacting the beat value, such as drift in response to impacts, phenomena induced by exposure to magnetic fields or any other dispersive effect. Knowing the sign or the orientation of the beat value therefore represents a real benefit.

For example, at the level of the timepiece movement the following convention is chosen: the beat value is defined as positive when the neutral point line of the oscillator has a positive angular offset (anticlockwise direction as seen from the back, i.e. in the direction FH) relative to the line of centers passing through the pivot point of the shaft of the pallet assembly and the pivot point of the shaft of the oscillator. In the contrary case it is negative.

Thus in the FIG. 2 example the fact of moving a hairspring stud holder in the anticlockwise direction as seen from the back (in direction FH) corresponds to rendering the beat value more positive. This definition remains valid if the timepiece movement includes some other means for setting the beat value instead of the traditional hairspring stud holder.

Generally speaking and on the basis of the above formulas, the temporal and geometrical beat values will be of the same sign, the time t1 corresponding to the half-cycle of the exit function and the time t2 corresponding to the half-cycle of the entry function. This sign is positive for t1>t2. Of course, these sign conventions depend on the orientation of the line of centers, on the geometry of the escapement, or on the architecture of the timepiece movement. It is however easy to establish by analogy a convention for each caliber.

Until now the sense or sign or orientation of the beat value could be determined only by moving the hairspring stud holder in a given direction and measuring the evolution of the beat value, which led to the loss of the initial setting of the beat value. In fact, the methods known until now do not make it possible to determine the sign of the beat value without effecting a plurality of successive settings and measurements.

Although never used until now, the sign of the beat value is information of primordial importance for the analysis of this magnitude and for effecting adjustments of the timepiece movement. As described in detail below, a number of techniques are possible for determining the sign, in particular a plurality of acoustic measurements, an opto-acoustic measurement, an analysis of an unprocessed signal, a measurement in a non-Galilean frame of reference, etc.

The embodiment of the method for determining the beat value described below uses the radial play of the balance pivot. The applicant's data reveals that this play has an influence on the beat value: the latter varies strongly depending on the vertical orientation of the timepiece movement (for example in the timepiece 3H, 6H, 9H, 12H positions). Numerical adjustment enables determination of the beat value and its sign in accordance with a model that is particularly simple to implement with known equipment, in particular with acoustic measurement equipment.

### Method for Determining a Beat Value

One embodiment of a method for determining a signed beat value in a timepiece movement is described in detail hereinafter. The method may utilize acoustic measurements carried out in a number of positions, in particular in the four vertical horological positions. On the basis of conventions and a theoretical model that uses the play of the balance pivot it is possible to sign beat value results initially measured as an absolute value. The principle consists in comparing and adjusting a sinusoidal regression function best matching the measured beat values obtained at different positions, for example best matching four beat value measurements obtained at different vertical positions.

Generally speaking, for determining, in particular for calculating, a beat value of the oscillator 2 in the timepiece movement 200 the method includes at least the following steps:
Causing the oscillator to oscillate relative to the frame 99 of the timepiece movement,
Positioning the timepiece movement in at least two distinct positions defined (or determined) relative to the direction of terrestrial gravity,
For each position, determining, in particular by measurement and processing, data relating to the beat value of the oscillator 2, particularly an absolute beat value of the oscillator 2,
Using data from the preceding step to determine the beat value of the oscillator 2, in particular to calculate:
   an oriented beat value of the oscillator 2, and
   a function defining the oriented beat value of the oscillator 2 depending on the position of the timepiece movement relative to the direction of terrestrial gravity.

The positions are defined, that is to say that the spatial orientations of the timepiece movement are known.

The beat value is an oriented value or a signed value, that is to say a value that can be positive or negative.

The beat value may be a temporal value, in particular a temporal value expressed in milliseconds. Such a value is dependent on the frequency of the oscillator and the amplitude of the oscillations of the balance.

The beat value is preferably a geometrical value, in particular an angle value expressed for example in degrees. Such a value has the advantage of being independent of the frequency of the oscillator and of the amplitude of the oscillations of the balance.

The method is executed when the oscillator is in motion. In fact, the method performs various actions, in particular measurements, when the oscillator is in motion. The method therefore includes a step of starting movement of the oscillator. This can be achieved by rearming the barrel so that the latter stores sufficient energy for nominal functioning of the timepiece movement.

The timepiece movement is positioned successively in at least two determined positions, i.e. distinct and defined positions, relative to the direction of terrestrial gravity. For example, these positions may include beat horological positions in which the timepiece movement is vertical, in particular a 3H position, a 6H position, a 9H position, a 12H position or any intermediate vertical position between two of the aforementioned vertical positions.

The method can be executed by positioning the timepiece movement in a number of distinct positions relative to the direction of terrestrial gravity.

The horizontal horological positions, in particular the positions FH and CH, are not desirable for executing the determination method.

For each position data relative to the beat value of the oscillator 2 is determined. For example, acoustic data is used enabling determination, in particular by calculation, of the beat value data in accordance with the formula |(t1−t2)/2| as stated above. For example, to do this beat value data is measured in each position. For example, variations in the intensity of an acoustic phenomenon are measured and an acoustic signal is obtained. It is possible to determine the values t1 and t2 by processing this signal.

These values are then used in processing or calculation to determine an absolute beat value.

The beat value data obtained in the simplest manner is temporal beat value data (not signed and not oriented).

However, the method advantageously includes a step of:
determining an amplitude of oscillation of the oscillator 3, or
measuring the amplitude of the oscillation of the oscillator
   at the moment at which the beat value data is measured or determined. The method advantageously further includes a step of using the amplitude of oscillation of the oscillator 2 to determine by calculation angular beat value data corresponding to the temporal beat value data.

If the amplitude of oscillation of the oscillator does not vary much or at all during all the measurements in the various positions it is possible to determine, in particular by measurement and calculation, the amplitude of the oscillation only once and to assume that this amplitude is constant during all of the measurements effected in the various positions.

If the amplitude of oscillation of the oscillator varies during all the measurements in the various positions it is preferable to determine the amplitude of the oscillation of the oscillator in each position and to associate the various amplitudes measured at the various positions with the beat value data obtained in the various positions.

The amplitude may be determined, in particular measured, in one and/or both distinct and defined positions. Alternatively the amplitude may be determined, in particular measured, in any other position.

Finally, the data relating to the beat value (temporal beat value data and where applicable oscillator amplitude data) is used to determine by calculation the beat value of the oscillator 2, in particular to calculate:
an oriented beat value of the oscillator 2, and/or
a function defining the oriented beat value of the oscillator 2 depending on the position of the timepiece movement relative to the direction of terrestrial gravity.

This step preferably uses all the beat value data obtained and the opposite values thereof to define 2n data combinations (assuming that the timepiece movement was positioned in n positions and that beat value data was obtained for each position). Each of these positions is associated with an angle λ (see the standard NIHS 95-10). There is then looked for the combination best correlated with a sinusoidal function expressing the beat value as a function of the angle λ, and that function is then retained as the expression of the beat value of the timepiece movement tested as a function of the angle λ, that is to say as a function of the position of the timepiece movement relative to the direction of terrestrial gravity.

If the architecture of the timepiece movement is known it is possible to determine aberrant combinations as explained below. For example, a combination will not be retained if it indicates minimum beat value data determined in a position in which the beat value data should be maximum.

In situations in which the position of the timepiece movement is neither a vertical position nor a horizontal position, the angle 2 of orientation of the timepiece movement is the oriented angle between:
an orientation starting from the center of the dial and pointing toward the 12H index, and
the orthogonal projection of an upward vector parallel to the direction of terrestrial gravity onto the dial or onto a plane perpendicular to the pivot axis of the oscillator or onto a main plane P of the timepiece movement i.e. onto the frame of the timepiece movement.

This angle has a positive orientation on going from the orientation pointing toward the 12H index to the orientation pointing toward the 3H index, i.e. turning in the clockwise direction over the dial.

The signed beat value concept is advantageously combined with that of the geometrical beat value to obtain a new definition of the beat value that directly links the value determined to the physical cause and offers numerous possibilities of use for improving the chronometric performance of the timepiece movement as well as improved efficiency during assembly and adjustment operations. In particular, as stated above, a signed geometrical beat value is an oriented angle value independent of the amplitude of the oscillations of the balance and of the frequency of the oscillator.

It appears that plays in the timepiece movement, in particular a radial play of the balance pivot, modify the beat value depending on the orientation of the timepiece movement relative to the direction of terrestrial gravity. In fact, the balance shaft has a shake (axial) and a play (radial). In a vertical position the balance pivots will bear on the pivot jewels, the effect of which is to move the center of rotation of the oscillator relative to the frame. The orientation of the line of centers is also modified by this, thereby changing the beat value. For example, for a given caliber an estimate of the variation of the beat value induced by the position difference of the pivot between a center pivot and a pivot bearing on the pivot jewel gives a value of 0.76°, which corresponds to a temporal beat value of 0.25 ms with an amplitude oscillation of 240° and an oscillator frequency of 4 Hz. A beat value at short intervals throughout a complete rotation in vertical positions about an axis perpendicular to the frame and/or to the dial of the timepiece movement enables observation of a total variation of the beat value of the order of 0.5 ms. This play phenomenon therefore seems to explain the beat value variations observed in practise.

As the beat value depends on the position of the timepiece movement it is possible to establish a model that relates these two variables and therefore enables determination of the sign of the beat value measured in the various positions. It nevertheless appears necessary to establish conventions in order for the reasoning always to be conducted in the same frame of reference.

The term orientation (the angle λ in the standard NIHS 95-10) is used to designate the angular position of the timepiece movement in a vertical position relative to its center. A value of 0° corresponds to the 12H position.

The orientation is positive when the timepiece movement seen from the dial side (in the direction CH) turns in the anticlockwise direction: it goes from the 12H position (0°) to 3H (90°) and so on. The inclination (the angle ϑ in the standard NIHS 95-10) is the angle defined between a vertical axis oriented in the opposite direction to that of terrestrial gravity (the axis Z in the standard NIHS 95-10) and the plane P of the timepiece movement. The position as seen from the dial side is defined as 90° and the position as seen from the back is defined as −90°.

It is also necessary to define a sign convention, namely that the beat value is increasingly positive when the line from the neutral point (passing through the pivot point of the pivot shaft of the oscillator and the center of the pin in the rest position of the balance) is moved in the anticlockwise direction as seen in the direction FH relative to the escapement line (or line of centers, which is the line situated in the plane P of the timepiece movement that passes through the pivot shaft on the oscillator and the pivot shaft of the pallet assembly).

Knowing that the beat value depends on the pivot play, it is equally possible to define orientations that correspond to the minimum and the maximum beat value data.

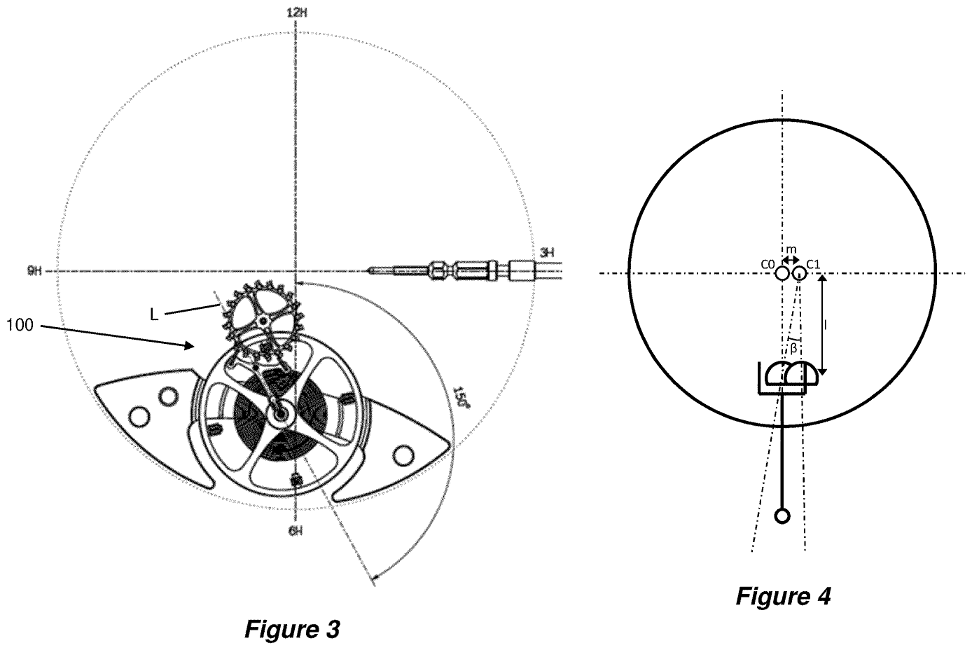

FIG. 3 shows a setting system 100 from the side CH in the 12H position (λ=0°, ϑ=90°). The extreme beat value must be noted when the line of centers L is in the horizontal position. Knowing that the line of centers L is inclined at 150° relative to the 12H position, the extreme beat values and the middle beat value are given for the following orientations (relative to 12H):
300° or 60°. The beat value is at its minimum value.
120° or 240°. The beat value is at its maximum value.
30° or 150°. The beat value is at its middle value, called the “beat value at mid-point”.

In this situation where a measurement (in absolute value) indicates a high beat value (higher than the other measured values) associated with a position at which the beat value should be the minimum it may be deduced that the beat value is negative in this position and that it is therefore necessary to consider a negative value.

It is possible to establish a theoretical model for defining the beat value as a function of the position of the timepiece movement relative to the direction of gravity. To a first approximation the beat value tracks a function of the following type:

$$R ( λ ) = R 0 \times sin ( λ - φ ) + M$$

with:
R(λ): beat value (signed or oriented) as a function of the orientation of the timepiece movement, expressed temporally in [ms] or geometrically by an angle in [°]
R0: amplitude of the sinusoidal function, always positive,
λ: orientation of the timepiece movement relative to the direction of terrestrial gravity (0-360°),
φ: phase-shift determined or defined by the architecture of the timepiece movement, in particular determined or defined by the direction of the line of centers,
M: positive, zero or negative offset (corresponding to the beat value at the mid-point, that is to say when the orthogonal projection of the direction of terrestrial gravity onto the dial or onto a plane perpendicular to the pivot axis of the oscillator or onto the main plane P of the timepiece movement or onto the frame of timepiece movement is parallel to the line of centers).

The parameter φ being predefined on the basis of the architecture of the timepiece movement, based on beat value data measured for different positions of the timepiece movement, it remains only to calculate the parameters R0 and M to define the beat value of a timepiece movement for all its positions relative to the direction of terrestrial gravity. A solution may be obtained using a least squares method to determine by calculation a sinusoidal function best matching the data relating to the beat value of the oscillator measured in different positions of the timepiece movement.

The parameter M corresponds to the theoretical beat value that the oscillator would have if there were no play in the pivots. The term “mid-point” or “beat value at the mid-point” for this parameter M may be used because it makes it possible to describe the global or average behavior of the beat value and is equal to the mean of the beat values obtained in four vertical positions spaced by 90°, for example in the four vertical horological positions.

As stated above, the beat value data obtained by measurement is all positive. However, depending on the adjustment of the timepiece movement, the signed beat value data may be all positive or all negative or, if the timepiece movement is correctly adjusted to the beat value, some may be positive and some negative.

For example, in a first phase absolute beat value data is measured in the four vertical test positions. Table 1 below shows the results obtained.

TABLE 1

| Position | Orientation λ [°] | Beat [ms] |
|---|---|---|
| 3H | 90 | 0.068 |
| 6H | 180 | 0.361 |
| 9H | 270 | 0.429 |
| 12H | 0 | 0.022 |

In a second phase the sign of each measurement is determined. In fact, on the basis of these four measurements, 2⁴=16 combinations of signed values would be possible. It is necessary to determine the combination of signed values that effectively corresponds to the result of the test performed on the timepiece movement. Because of the known architecture of the timepiece movement under test it has been possible to establish that the beat value data in position 3H is closest to the minimum and the beat value data in position 9H is closest to the maximum. Because of this the combinations to be retained must satisfy the following condition: Beat value (3H)<Beat value (9H). In most cases this condition enables the number of solutions to be reduced. Furthermore, the sign of the data may be determined by fitting the function R(λ) to the data by trying different sign combinations. The most probable solution is that which for example minimizes the sum of the squares of the differences between the theoretical function R(λ) and the points defined by the various data combinations referred to above. Other optimization or regression methods may be used.

In a third phase the final solution is expressed in the following form, the beat values being those measured to which have been added the sign of the values calculated in accordance with the theoretical model established using the data obtained during the test carried out on the timepiece movement:

TABLE 2

| | Refence value | Difference between measurement |
|---|---|---|
| Position | [ms] | and model [ms] |
| 3H | −0.068 | −0.006 |
| 6H | 0.361 | −0.025 |
| 9H | 0.429 | 0.017 |
| 12H | 0.022 | 0.014 |

On the basis of the model that has been established it is also possible to determine by calculation the beat value at the mid-point (i.e. in the position of the timepiece movement in which the projection orthogonal to the direction of terrestrial gravity onto the dial or onto the plane perpendicular to the pivot axis of the oscillator or onto the main plane of the timepiece movement or onto the frame of the timepiece movement) is parallel to the line of centers). This beat value at the mid-point has the value +0.19 ms (or 0.57° for the beat value expressed in the geometric manner). Thus the function defining the oriented angular beat value according to the position of the timepiece movement (orientation λ) can be determined as a sinusoidal function (of the orientation λ of the timepiece movement) best matching the data relating to the beat value of the oscillator. Thanks to such a sinusoidal function it is possible to interpolate the beat value of the timepiece movement in any of its positions (provided that the direction normal to the dial is at an angle of at least 2°, preferably at least 3°, to the direction of terrestrial gravity). It is therefore possible to determine a beat value for a position of the timepiece movement in which no beat value measurement has been done.

The foregoing example clearly indicates the limitations of the traditional definition of the beat value and of the corresponding measurement (absolute temporal beat value): the measurements in vertical positions yield two values close to zero (0.02 and 0.07 ms) and two values close to the maximum tolerance (0.36 and 0.43 ms). It is difficult for the watchmaker to set the beat value: should they leave the timepiece movement as is on the basis of one of the measurements close to zero obtained or correct it on the basis of one of the other two measurements obtained? Furthermore, if the watchmaker were to gamble on effecting a correction, what beat value would they have to attempt to achieve? In fact, although the mean of the signed beat values measured in four vertical positions is equal to the beat value at the mid-point, the same does not apply to the mean of the four “standard” measured absolute beat values. It is seen that the usual injunction to “set the beat value to zero in all positions” is simply not achievable in practise.

As indicated hereinabove other approaches may be envisaged for determining the sign of the beat value instead of or in addition to the adjustment of the measurements by means of a sinusoidal function. A few theoretical ideas are described below.

### Distinguishing the Sign Using the Acoustic Signature

As a general rule, and in particular in the case of Swiss pallet escapements, the acoustic signatures between two successive half-cycles are difficult to distinguish. Because of this acoustic equipment does not take account of this criterion. However, on certain calibers and certain types of escapement this difference is very clear and can be used to deduce the sign of the timepiece movement. By extending the concept, the distinction of each signature specific to each caliber could be achieved by means of supervised classification algorithms (K Nearest Neighbors, Support Vector Machine or Neural Network).

### Distinguishing the Sign Using Opto-Acoustic Measurement

Failing measurement of the beat value, (dual channel) optical measurements make it possible to know the direction of passage of the balance on each half-cycle. By combining this technology with an acoustic measurement it becomes possible to determine the direction of a half-cycle for each time measurement and therefore to deduce therefrom the sign of the beat value.

### Distinguishing the Sign Using Excitation of the Timepiece Movement

It is not generally possible to distinguish the “tick” from the “tock” during an acoustic measurement. This problem can be worked around by producing a first measurement in a stationary state (timepiece movement fixed) and then a second measurement with an angular acceleration the direction of which is known. If the acceleration is done with a center of rotation coinciding with that of the balance and the hairspring (non-Galilean frame of reference) the balance is subjected to a torque that generates an angular offset at the level of the hairspring. The beat value is then falsified depending on the angular displacement applied at the level of the hairspring. The sign of the beat value can be deduced by observing if the beat value increases or decreases during the measurement when there is acceleration: for example, if the beat value increases when the roller is rotating it will be clear that there is a departure from zero compared to the stationary measurement. Thus it becomes possible to determine the sign of the beat value. The sign of a beat value very close to zero could be difficult to identify, however. One improvement would be to apply a progressive acceleration, initially very low to be able to detect the evolution of the measurement and possibly a change of sign when the torque increases. An alternative method consists in exciting the timepiece movement by a short pulse at a very precise time so that this disturbance is synchronized with a half-cycle of the timepiece movement when the oscillator is close to the escapement function (in the middle of the half-cycle). Given that the orientation of the pulse is known but that the “tick” and “tock” half-cycles remain to be identified, an arbitrary disturbance to one of them would generate either an increased or a decreased amplitude. The algorithm will therefore be in a position to associate the half-cycles with the direction of rotation of the balance. The sign of the beat value can be identified because of this.

As stated above, the use of the signed beat value, in particular of the signed geometric beat value, enables determination of the mid-point, i.e. the effective offset between the neutral point of the oscillator and the line of centers. It must be remembered that the traditional measurement yields an absolute value. The results obtained by the applicant show that this beat value expressed temporally depends on the amplitude, which it is therefore variable between the horizontal and vertical positions, and that it typically varies by 0.5 ms between the extreme values measured in vertical positions because of the pivot play.

As stated above, the method preferably includes a phase of seeking a better fit of a sinusoidal function to the measurement points by trying different combinations of signs of the measurement data obtained. Such a phase may be applied in a production stream.

The “global” beat value of each timepiece movement can therefore be expressed via the beat value at the mid-point (table 3). This demonstrates the benefit of using a signed beat value. Table 3 shows three instances: The beat value is far from zero and positive. The standard absolute mean values offer a good approximation of the beat value at the mid-point, or even the correct value if the mean value for the four vertical positions (timepiece movements 3, 5) is considered. This is not surprising given the explanations developed hereinabove.

The beat value is far from zero and negative (timepiece movements 2, 4). The same characteristics as above are found again, but with the sign reversed: the absolute value will be systematically wrong. This has direct consequences on the setting of the beat value: the watchmaker will for example be obliged to carry out at least two cycles of adjustment and verification measurement.

The beat value is close to zero (timepiece movement 1). In this case the mean of the values differs from the mean of the absolute values, causing a significant error (by a factor of 2 in the example) in the beat value, which again underlines the benefit of the approach developed in the present document.

TABLE 3

| | Beat | | Absolute beat | Absolute beat |
|---|---|---|---|---|
| | value at | Absolute beat | value, mean of | value, mean |
| Timepiece | mid-point | value, mean of | 2 horizontal | of 4 vertical |
| movement | [°] | 6 positions [°] | positions [°] | positions [°] |
| 1 | 0.16 | 0.27 | 0.18 | 0.31 |
| 2 | −0.51 | 0.52 | 0.54 | 0.51 |
| 3 | 0.63 | 0.66 | 0.73 | 0.63 |
| 4 | −0.93 | 0.90 | 0.84 | 0.93 |
| 5 | 1.27 | 1.40 | 1.66 | 1.27 |

In the embodiment described in detail above the determination method is applied to the timepiece movement in vertical positions, that is to say with the balance axis perpendicular to the direction of terrestrial gravity. The work carried out by the applicant shows that it is necessary to avoid employing the determination method with the timepiece movement in a horizontal position. Nevertheless, as soon as an angle of approximately 2°, preferably 3°, or greater can be measured between the axis of the oscillator and the direction of terrestrial gravity, the timepiece movement is in a position appropriate for the effective use of the determination method. This condition can be respected in one position or in some or all positions in which the timepiece movement is placed in order to determine beat value data.

In the situation where the timepiece movement is not in a vertical position or in a horizontal position the orientation angle % of the timepiece movement is defined as already indicated above, that is to say as the oriented angle between:
an oriented direction from the center of the dial or of the timepiece movement pointing toward a 12H index, and
the orthogonal projection onto the dial or onto a plane perpendicular to the pivot axis of the oscillator or onto the main plane of the movement or onto the frame of the timepiece movement of an upward vector parallel to the direction of terrestrial gravity.

At least one of the positions defined is preferably such that the angle between:
the orthogonal projection of the line of centers L (the line connecting the oscillation axis of the oscillator and the pivot axis of the pallet assembly 31, perpendicular to those two axes) onto the dial of the timepiece or onto a plane perpendicular to the pivot axis of the oscillator or onto the main plane of the timepiece movement or onto the frame of the timepiece movement, and
the orthogonal projection of the direction of terrestrial gravity onto the dial of the timepiece or onto a plane perpendicular to the pivot axis of the oscillator or onto the main plane of the timepiece movement or onto the frame of the timepiece movement
   is zero or has an absolute value less than 5° or an absolute value less than 10°.

At least two defined and distinct positions are preferably vertical positions of the timepiece movement with an angle of approximately 90° between them about an axis perpendicular to the frame and/or to the dial (the axis X according to the standard NIHS 95-10) and/or an angle of at least 90° between them. More generally, at least two defined and distinct positions are positions of the timepiece movement such that the orientation angle λ difference of the timepiece movement between these two positions is 90° or approximately 90° or at least 90°.

It is highly advantageous if at least one first defined position of the timepiece movement is such that the angle between:
the orthogonal projection of the line of centers L onto the dial of the timepiece or onto a plane perpendicular to the pivot axis of the oscillator or onto the main plane of the timepiece movement or onto the frame of the timepiece movement, and
the orthogonal projection of the direction of terrestrial gravity onto the dial of the timepiece or onto a plane perpendicular to the pivot axis of the oscillator or onto the main plane of the timepiece movement or onto the frame of the timepiece movement
   is zero or has an absolute value less than 5° or an absolute value less than 10°, and
   at least one second position of the timepiece movement is such that the orientation angle A difference of the timepiece movement between these first and second positions is ±90° or approximately ±90°, and, optionally, a possible third position of the timepiece movement is such that the orientation angle λ difference of the timepiece movement between these first and second positions is ±90° or approximately ±90°,
   the second and third positions being distinct positions, that is to say positions such that the orientation angle λ difference of the timepiece movement between these second and third positions is 180° or approximately 180°.

The second and third positions are therefore advantageously defined and distinct positions such that the angle between:
the orthogonal projection of the line of centers L onto the dial of the timepiece or onto a plane perpendicular to the pivot axis of the oscillator or onto the main plane of the timepiece movement or onto the frame of the timepiece movement, and
an orthogonal projection of the direction of terrestrial gravity onto the dial of the timepiece or onto a plane perpendicular to the pivot axis of the oscillator or onto the main plane of the timepiece movement or onto the frame of the timepiece movement
   has the value 90° or an absolute value between 85° and 95° or an absolute value between 80° and 100°. In such second and third positions it is possible to measure extreme beat values or values close to extreme beat values.

As a general rule the determination of the beat value will be all the more reliable and precise as the number of measurement points increases. For a timepiece movement of unknown architecture it is recommended to position the timepiece movement in at least three, preferably four, positions, in particular in four vertical positions or positions inclined at least at 2° relative to the horizontal. When the architecture of the timepiece movement is known, and therefore the positions of the minima, zeros and maxima of the theoretical sinusoidal function R(λ) are known, it is possible to place the timepiece movement in only two vertical positions (or positions inclined at least at 2° relative to the horizontal) and to determine the value by elimination, in particular by excluding certain sign combinations that do not comply with the sign convention and/or the physical reality (too high a resultant amplitude R0). The measurement positions may advantageously be spaced by 90° or by more than 90° or correspond to positions for which the function R(λ) has a maximum or a minimum value.

Regardless of the embodiment or the variant execution of the method, the data relating to the beat value of the oscillator 2 (absolute temporal beat values) and/or oscillation amplitudes of the oscillator 2 is for example determined by processing acoustic signals measured or acquired previously or by processing acoustic and optical signals measured or acquired previously.

### Method for Setting the Beat Value

The beat value is set systematically on each timepiece movement or watch, either manually (for example by a watchmaker during after-sales service or on a manual production stream), or automatically (for example in an automatic production facility). Until now the absence of a sign for the beat value has not only been problematic for setting the beat value but has also limited industrial control of this magnitude, in particular by rendering the statistical analyses difficult.

The usual approach for setting the beat value has consisted in carrying out an iterative series of acoustic measurements. After each measurement the hairspring stud holder is moved through a certain angle depending on the beat value measured in the preceding iteration, gambling on the direction of movement during the first cycle. By measuring the beat value before and after correction and knowing the direction in which the hairspring stud holder has been moved it is possible in most cases to deduce the direction in which to correct the beat value. Another possibility is to move the hairspring stud holder a long way in one direction so that there is no doubt as to the sign of the beat value and to set the beat value accordingly. This way of proceeding is laborious however because it relies on a plurality of measurements and modifications of the position of the hairspring stud holder to arrive at the required value in an iterative manner.

Thanks to the solutions described above the question of the direction of movement of the hairspring can be settled even before the first touch-up iteration, therefore limiting manipulation of the hairspring stud holder. Neither do parts having from the outset a beat value within the tolerances need to be misadjusted to identify the sign of the beat value. For example, to do this a series of measurements in vertical positions enable identification of the sign of the beat value as explained above. Expressed as a signed geometric beat value, this measurement also makes it possible to quantify the beat value through the mid-point, which reflects the overall behavior of the timepiece movement.

One way of executing a method for adjusting the setting system 100 or the oscillator 2 is described hereinafter. The method includes:
a phase of executing the method according to the invention for determining the beat value, in particular a phase employing one way of executing the determination method described above, and
a phase of setting the beat value of the oscillator 2.

The phase of setting the beat value advantageously includes movement of a hairspring fixing support relative to the escapement and/or to the frame 99.

It would therefore appear to be effective:
to measure the beat value in a number of vertical positions, for example four mutually orthogonal positions, and
to determine by calculation the beat value at the mid-point by adjustment of a function, for example a sinusoidal function, or any function that is appropriate, such as a polynomial or Bezier or spline function, at the measurement points.

This setting method enables the beat value to be set in a single operation without employing iterative tests and directly targeting the correct value. The correction is all the more effective when it determines the signed geometrical beat value, which yields directly the correct angular value and the correct direction for the correction. This procedure for measuring the beat value and setting the beat value using the signed beat value enables centering of the distribution on a correct value, as well as controlling and reducing dispersion.

The setting method described above is robust in that it enables reliable and precise adjustment of any timepiece movement. However, this method can be improved (in particular in terms of the time taken and the means employed) with a knowledge of the architecture and/or the type of escapement of the timepiece movement to be adjusted.

Work carried out by the applicant makes it possible to predict future evolutions of the beat value of a known timepiece movement as a function of the support on which that timepiece movement rests. Knowing the orientation of the setting system in the timepiece movement, it is possible to determine a favorable position for setting the beat value. In particular, the position retained positions the timepiece movement with a known orientation 2. As a result of this it is possible to determine the optimum beat value to be set in such a position, which value may be a zero value, a maximum value, a minimum value or any other intermediate value.

To carry out such an adjustment the timepiece movement is preferably positioned so that the normal to the dial is at an angle θ to the direction of terrestrial gravity of at least 2°, preferably at least 3°. Any angle θ greater than 10°, in particular greater than 30° or greater than 45°, would also appear particularly interesting for a watchmaker from an ergonomic point of view.

Thus another way of executing a method for adjusting the setting system 100 or the oscillator 2 employs:
a phase of positioning the timepiece movement in a predefined position, and
a phase of setting the beat value to a defined value, in particular a zero or close to zero value, in this predefined position.

In particular, depending on the position adopted, and in contrast to what is known from the prior art, it is also possible to proceed to setting the beat value by attempting to achieve a non-zero beat value. Benefitting from the influence on the measurement of the beat value of the orientation of the timepiece movement, it is also possible to specify the orientation of the latter during setting so that a target at zero in this orientation makes it possible to achieve a given beat value at the mid-point.

This adjustment may be employed for any type of escapement, including a Swiss pallet escapement. It is however especially pertinent for asymmetric escapements, like the Robin escapement, for which the beat value has an influence on rate.

Thus another way of executing a method for adjusting the setting system 100 or the oscillator 2 employs:
a phase of placing the timepiece movement in a predefined position, and
a phase of setting the beat value to a non-zero value in this predefined position.

The phase of setting the beat value advantageously includes movement relative to the frame 99 of a support for fixing the hairspring.

The various ways of executing the setting method may advantageously be combined.

Thanks to the setting method in accordance with the invention the timepiece movement can be positioned so that the angle between:
the orthogonal projection of the line of centers L on the dial or on a plane perpendicular to the pivot axis of the oscillator or onto the main plane of the timepiece movement or onto the frame of the timepiece movement, and
the orthogonal projection of the direction of terrestrial gravity onto the dial or onto a plane perpendicular to the pivot axis of the oscillator or onto the main plane of the timepiece movement or onto the frame of the timepiece movement
   is zero or substantially zero, and
   consequently, there may be employed a phase of setting the beat value in which there is attempted the closest possible approximation to a zero beat value setting.

Alternatively the timepiece movement may be positioned in some other predefined position, in particular so that the angle between:
the orthogonal projection of the line of centers L on the dial or on a plane perpendicular to the pivot axis of the oscillator or on the main plane of the timepiece movement or on the frame of the timepiece movement, and
the orthogonal projection of the direction of terrestrial gravity on the dial or on a plane perpendicular to the pivot axis of the oscillator or on the main plane of the timepiece movement or on the frame of timepiece movement is a right angle or substantially a right angle, and
   consequently, there may be employed a phase of setting the beat value in which it is attempted to approximate as closely as possible a non-zero beat value setting.

Using the setting method described above it is possible to obtain a timepiece movement 200 that is correctly adjusted or a timepiece 300, in particular a wristwatch, that is correctly adjusted.

### Method for Determining Drift of a Beat Value Between Two States

During testing or approval of a timepiece movement the aim is to analyze the beat value and its drift in various states, for example before and after impacts or before and after magnetization or more generally before and after an external load or an intervention. This ideally necessitates a knowledge of the sign of the beat value in order to determine the amplitude and the direction of the drift or movement. In this case moving the hairspring stud holder to determine the beat value and the sign cannot be envisaged and until now only the absolute beat value could be measured. This lack of knowledge with respect to the sign was a major problem. For example, a measurement in two states could lead to a zero drift conclusion whereas in reality the beat value had been moved to double its initial value on changing sign. A greater nuisance was that the random aspect at the level of the sign of the drift value did not enable this result to be linked with the physical phenomena linked to impacts (deformation of the hairspring, movement of the hairspring stud holder, etc.). Here the utility of knowing the sign of the beat value is clearly apparent.

Accordingly, one way of executing a method for determining drift of a timepiece movement after an impact or magnetization includes a phase of determining the beat value of the oscillator 2 using the method described above for determining a beat value. Two phases of determining the beat value of the oscillator 2 are preferably executed using the method described above for determining a beat value, the first phase before the impact or magnetization and the second phase after the impact or magnetization.

### Method for Determining a (Previously Unknown) Geometry of an Arrangement of an Oscillator in a Timepiece Movement

The variations of the beat value as a function of the positions of the timepiece movement relative to the direction of terrestrial gravity are linked to the play in the setting system 100, in particular the radial play of the balance shaft. The balance pivots, because of the effect of gravity, adopt positions in their jewels depending on the orientation of the timepiece movement. As FIG. 4 shows this movement of the pivot from the center C0 to the position C1, characterized by the pivot half-play m, then modifies the direction of the escapement line and therefore the beat value. Although the variations of the beat value are theoretically explained by the pivot play, a reverse methodology enables calculation of that play based on measurements of the beat value.

Based on the FIG. 4 illustration, a simple relation between the pivot play and the beat value is given by:

$$β = arc tan ( m / I )$$

with:
β: relative angle between the line of centers and the neutral point for a movement by a radial half-play (which corresponds to the amplitude of the sinusoidal function defining the signed geometric beat value),
m: pivot radial half-play,
l: distance between the axis of the balance pivot and the roller pin.

For nominal values of 8 μm for m and 0.6 mm for l, the numerical application gives β=0.76°, which corresponds to an entirely normal value.

The above simple relation assumes that the pivots are cylindrical and can be developed to take account of the conical nature of the pivots and consequently also enables deduction of the axial shake of the balance shaft.

Alternatively, if the diameter of the hole in the pivot jewels is known precisely it is also possible to deduce the diameter of the balance pivots from beat value measurements.

Accordingly, in one way of executing a method for determining a geometry of an arrangement of an oscillator 2 in a timepiece movement 3 the method includes:
a phase of determining a function defining the beat value depending on the position of the timepiece movement using the method for determining a beat value described above, and
a phase of using the function to determine, in particular by calculation, a value representing the radial pivot play of the oscillator 2 and/or a value representing the axial shake of the balance shaft and/or a value representing the diameter of the balance pivots.

For example, by using the method described above for determining a beat value it is possible to determine the value of the amplitude of the sinusoidal function referred to above. Then, based on the maximum angular beat value and the known distance between the axis of the balance pivot and the roller pin, it is possible to determine the value of the pivot play of the oscillator using the formula β=arctan (m/l).

The “frame” concept used in the present document can be replaced by the “module” concept, for example if the oscillator-escapement system is mounted and/or adjusted on a timepiece module intended to be assembled afterwards onto a frame.

Throughout the present document, so as not to burden the formulations, the term “beat” may have been used to mean “beat value”.

Throughout the present document by “plane of the timepiece movement” or “main plane of the timepiece movement” is meant a plane perpendicular to the axes of the finishing train mobiles. This plane is for example perpendicular to the pivot axis of the oscillator. This plane is preferably the plane in which the timepiece movement lies. For example, this plane:
is tangential to the largest surface of the frame oriented perpendicularly to the axes of the finishing train mobiles, or
passes through the location on the frame at the level of which the dial is positioned.

By “determining a value” is meant a set of at least one step for establishing a value or quantifying a thing or a phenomenon. These steps include:
at least one measurement, and/or
at least one calculation, and/or
at least one mathematical or logical or computer process.

By “determining a function” is meant a set of at least one step for establishing or defining the function, in particular the mathematical function, in particular and more precisely the coefficients and/or constants of said function. These steps include:
at least one measurement, and/or
at least one calculation, and/or
at least one mathematical or logical or computer process.

1. A method for determining a beat value of an oscillator in a timepiece movement, the method including:
causing the oscillator to oscillate relative to a frame of the timepiece movement,
positioning the timepiece movement in at least two positions defined relative to a direction of terrestrial gravity,
for each position, determining data relating to an absolute beat value of the oscillator,
using the data obtained from the determining to determine a beat value of the oscillator.

2. The method as claimed in claim 1, wherein the beat value is a temporal value.

3. The method as claimed in claim 1, wherein the oscillator has an oscillation axis at an angle of at least 2° to the direction of terrestrial in at least one of the positions in the positioning of the timepiece movement.

4. The method as claimed in claim 1, wherein at least one of the determined positions is so that an angle between:
an orthogonal projection of a line of centers on a plane of the timepiece movement, and
an orthogonal projection of a direction of terrestrial gravity on the plane of the timepiece movement has an absolute value less than 10°,
and/or wherein at least one of the determined positions is so that an angle between:
the orthogonal projection of the line of centers on the plane of the timepiece movement, and
the orthogonal projection of the direction of terrestrial gravity on the plane of the timepiece movement has an absolute value in a range of from 80° to 100°.

5. The method as claimed in claim 1, wherein at least two of the determined positions are vertical positions of the timepiece movement and/or positions at an angle of approximately 90° to one another about an axis perpendicular to the frame.

6. The method as claimed in claim 1, wherein a function defining the oriented beat value depending on the position of the timepiece movement is defined as a sinusoidal function or a polynomial function or a Bézier function or a spline function best matching the data relating to the beat value of the oscillator.

7. The method as claimed in claim 1, wherein the method includes determining an oscillation amplitude of the oscillator.

8. The method as claimed in claim 7, wherein the method includes using an oscillation amplitude of the oscillator to determine an angular beat value.

9. The method as claimed in claim 1, wherein the data relating to the beat value of the oscillator and/or the oscillation amplitude of the oscillator are determined by processing acoustic signals or by processing acoustic and optical signals.

10. A method of adjusting an oscillator, the method comprising:
carrying out the method as claimed in claim 1, and
setting the beat value of the oscillator.

11. A method of adjusting an oscillator, the method comprising:
positioning a timepiece movement in a predetermined position, and
setting a beat value to a zero value or to a non-zero value in the predetermined position.

12. The method as claimed in claim 10, wherein the setting of the beat value includes moving a hairspring fixing support relative to a frame.

13. A method of determining drift of a timepiece movement between two states, the method comprising determining a beat value of an oscillator using the method as claimed in claim 1.

14. A method for determining a geometry of an arrangement of an oscillator in a timepiece movement, the method comprising:
determining a function defining a beat value depending on a position of the timepiece movement using the method as claimed in claim 1, and
using the function to determine a value representing a radial pivot play of the oscillator and/or a value representing an axial shake of a shaft of the balance and/or a value representing a diameter of pivots of the balance.

15. A timepiece movement obtained using the method as claimed in claim 10.

16. A timepiece comprising a timepiece movement as claimed in claim 15.

17. The method as claimed in claim 1, wherein the oscillator is a balance and hairspring oscillator.

18. The method as claimed in claim 1, wherein the data obtained from the determining is used to determine an oriented beat value and/or a function defining the oriented beat value depending on a position of the timepiece movement relative to the direction of terrestrial gravity.

19. The method as claimed in claim 1, wherein the oscillator has an oscillation axis at an angle of at least 2° to the direction of terrestrial in at least a plurality of the positions in the positioning of the timepiece movement.

20. The method as claimed in claim 1, wherein the oscillator has an oscillation axis at an angle of at least 2° to the direction of terrestrial in all the positions in the positioning of the timepiece movement.
